(19) United States
(12) Patent Application Publication
(10) Pub. No.: US 2019/0107688 A1
(43) Pub. Date: Apr. 11, 2019

(54) OPTICAL DEVICE

(71) Applicant: NIKON CORPORATION, Tokyo (JP)

(72) Inventor: Masao NAKAJIMA, Kawasaki-shi (JP)

(73) Assignee: NIKON CORPORATION, Tokyo (JP)

(21) Appl. No.: 16/089,791

(22) PCT Filed: Mar. 27, 2017
(86) PCT No.: PCT/JP2017/012376

§ 371 Date: Sep. 28, 2018

(30) Foreign Application Priority Data
Mar. 30, 2016 (JP) 2016-069738

(51) Int. Cl. G02B 7/34; G03B 13/36; G02B 27/64; G03B 5/00; H04N 5/225; H04N 5/232

(52) U.S. Cl. CPC G02B 7/34; G03B 13/36; G02B 27/646; G03B 5/00; G03B 2205/0007; H04N 5/23258; H04N 5/23267; H04N 5/23212; H04N 5/22541

(57) ABSTRACT

An optical device includes: a plurality of microlenses arranged in a two-dimensional shape; and an image sensor having a plurality of pixel groups each containing a plurality of pixels, each of the plurality of pixel groups receiving light that has passed through each of the plurality of microlenses, wherein at least a part of the plurality of microlenses each limits a part of an incident light by an opening pattern formed at a microlense.

### TECHNICAL FIELD

The present invention relates to an optical device.

### BACKGROUND ART

A camera that uses Light Field Photography technology has been known (see PTL 1). If a camera of this type is provided with a VR (Vibration Reduction) device at its imaging lens to prevent image blurring due to, for example, camera shake, the camera will inevitably have a bigger structure, which is a problem to be solved.

### CITATION LIST

### Patent Literature

PTL1: Japanese Translation of PCT Application Publication No. JP-2008-515110A

### SUMMARY OF INVENTION

According to the 1st aspect, an optical device comprises: a plurality of microlenses arranged in a two-dimensional shape; and an image sensor having a plurality of pixel groups each containing a plurality of pixels, each of the plurality of pixel groups receiving light that has passed through each of the plurality of microlenses, wherein at least a part of the plurality of microlenses each limits a part of an incident light by an opening pattern formed at a microlense.

According to the 2nd aspect, an optical device comprises: a plurality of microlenses arranged in a two-dimensional shape; an image sensor having a plurality of pixel groups each containing a plurality of pixels, each of the pixel groups receiving light that has passed through each of the plurality of microlenses; and a plurality of masks each having a predetermined opening pattern, wherein each of the plurality of masks limits light that is incident to each of at least a part of the plurality of microlenses.

### BRIEF DESCRIPTION OF DRAWINGS

FIG. 1 is a diagram illustrating the construction of a main part of a camera;

FIG. 2 is a perspective view selectively illustrating an optical system of the camera;

FIG. 3 is a cross-sectional view of a microlens array and an image sensor;

FIG. 4 is a front view of the image sensor shown in FIG. 3 as seen from the +z axis direction;

FIG. 5 is an enlarged diagram illustrating one of the microlenses shown in FIG. 4;

FIGS. 6(a) and 6(b) are each a diagram illustrating an exemplary pattern of the opening of a mask; and

FIG. 7 is a diagram illustrating the arrangement of microlenses in the microlens array that are divided into two groups. [FIG 8] FIG. 8 is a flowchart illustrating the flow of processes performed by the control unit;

FIG. 9 is a diagram illustrating a second embodiment of the microlens array; and

FIG. 10 is a flowchart illustrating the flow of processes performed by the control unit.

### DESCRIPTION OF EMBODIMENTS

A camera, which is an example of the optical device, is constructed so that it can obtain information about light in a three-dimensional space by utilizing the light field photography technology. Image blurring due to, for example, camera shake, which may occur, is corrected by VR calculation.

### First Embodiment

Outline of Imaging Device

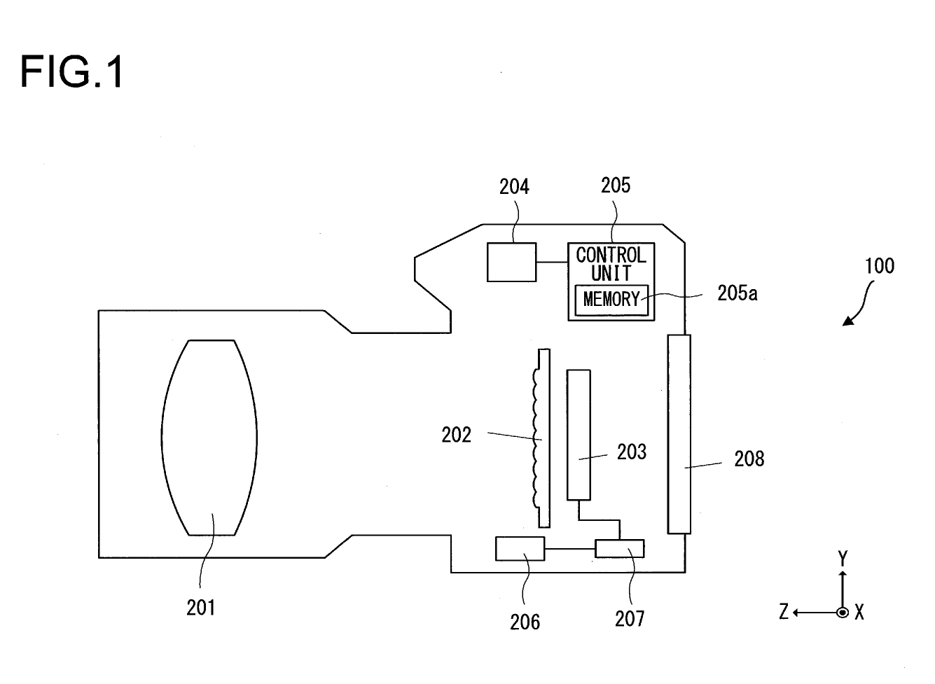

FIG. 1 is an explanatory diagram illustrating the construction of the main part of a camera 100 according to a first embodiment. In the coordinate system shown in FIG. 1, the light from an unshown subject proceeds in the −Z axis direction. The orientation that is upward and orthogonal to the Z axis is defined to be +Y axis direction. The orientation that is perpendicular to the paper and on this side of the paper and orthogonal to the Z axis and the Y axis is defined to be +X direction. In some figures referred to hereinafter, the orientations in the respective figures are indicated based on the coordinate axes used in FIG. 1 as the standards.

In FIG. 1, an imaging lens 201 is constructed to be interchangeable and is mounted on the body of the camera 100 when in use.

Note that the imaging lens 201 may be constructed to be integral with the body of the camera 100.

The imaging lens 201 guides the light from a subject to a microlens array 202. The microlens array 202 is constituted by arranging minute lenses (“microlenses L” described later) two dimensionally in a latticed pattern or in a honeycombed pattern. The light from the subject having entered the microlens array 202 passes through it and is photoelectrically converted by each of pixel groups in an image sensor 203.

A pixel signal after photoelectric conversion read out from the image sensor 203 is transmitted to an image processing unit 207. The image processing unit 207 performs predetermined image processing onto the pixel signal. The image data after the image processing is recorded in a recording medium 206 such as a memory card.

Note that the pixel signal read out from the image sensor 203 without being subjected to any image processing may be recorded in the recording medium 206 as so-called RAW data.

A shake detector 204 is constituted by, for example, an acceleration sensor. A detection signal produced by the shake detector 204 is used as acceleration information when the camera 100 swings due to, for example, camera shake.

A control unit 205 controls the imaging action of the camera 100. That is, it performs accumulation control in which the image sensor 203 is caused to store charges when photoelectric conversion proceeds and read-out control in which a pixel signal after the photoelectric conversion is caused to be outputted from the image sensor 203.

Also, the control unit 205 performs VR (Vibration Reduction) calculation based on the acceleration information. The VR calculation is performed to correct image blurring of the image caused by swinging or shaking of the camera 100. Details of the VR calculation are described later.

A display unit 208 reproduces and displays an image based on the image data. It also displays an operation menu screen. Control of display on the display unit 208 is performed by the control unit 205.

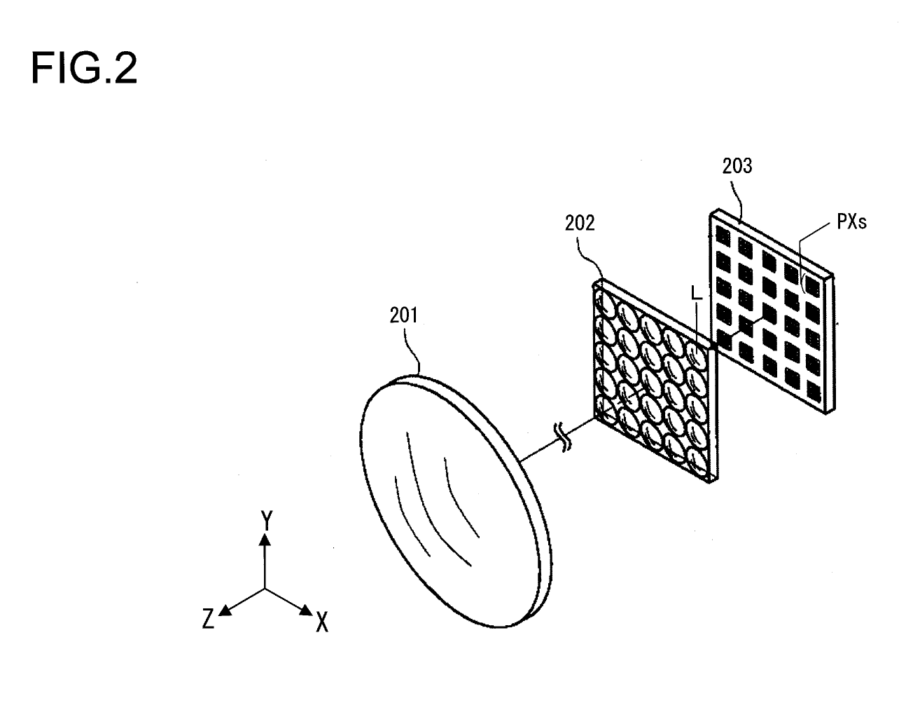

FIG. 2 is a perspective view selectively illustrating the optical system of the camera 100, which includes the imaging lens 201, the microlens array 202, and the image sensor 203. The microlens array 202 is arranged on a predetermined focal plane of the imaging lens 201.

For making it easier to understand, the microlens array 202 and the image sensor 203 are illustrated so that they are arranged in an enlarged distance therebetween. However, the actual distance therebetween is a distance that corresponds to the focal distance f of the microlens L that constitutes the microlens array 202.

Light Field Image

In FIG. 2, light beams from different parts of the subject enter each microlens L in the microlens array 202. The light beams that have entered the microlens array 202 are divided into a plurality of groups by the microlenses L that constitute the microlens array 202. Then, the light beams that have passed through the respective microlenses L enter pixel groups PXs at the image sensor 203 arranged behind the corresponding microlenses L (in the −Z axis direction).

Note that in FIG. 2, the microlens array 205 has 5×5 microlenses L. However, the number of the microlenses L that constitute the microlens array 202 is not limited to the number of the microlenses L illustrated.

The light beam that has passed through each microlens L is received by the pixel group PXs at the image sensor 203 that is arranged behind the corresponding microlens L (in the −Z axis direction). That is, the pixels PX that constitute the pixel group PXs receive light beams from some part of the subject having passed through different regions of the microlens 201, respectively.

The construction described above enables a plurality of small images, each of which is a light quantity distribution representing a region in which the light from the subject has passed through the imaging lens 201, to be generated as many as the number of the microlenses L. In this description, a collection of such small images is referred to as a light field image (LF image).

At the image sensor 203, the direction in which light enters each pixel depends on the position of each of the plurality of pixels PX arranged behind each of the microlenses L (in the direction of the −Z axis of). That is, since the positional relationship between the microlens L and each pixel at the image sensor 203 arranged behind it is already known as the design information, the direction in which the light beam that enters each pixel through the microlens L can be obtained. As a result, the pixel signal from each pixel at the image sensor 203 represents the intensity of light from a predetermined incident direction (light beam information). In this description, light that enters a pixel of the image sensor from a predetermined direction is referred to as a light beam.

Refocus Process

The data of an LF image can be used in a refocus process. The refocus process refers to a process for generating an image on any image plane, i.e., a process for generating an image at any focus position or viewpoint by performing calculation based on the information about light that the LF image has as described above (i.e., the intensity of light from the predetermined incident direction) (i.e., by performing calculation to rearrange light beams). In this description, an image generated at any focus position or viewpoint formed by the refocus process is referred to as a refocused image.

The refocus process includes not only increasing sharpness by putting any object into focus but also blurring (reducing sharpness) by shifting the focus for the object. Since such conventional refocus process (also referred to as a reconstruction process) is already known, detailed explanation on the refocus process is omitted.

Note that the refocus process may be performed by the image processing unit 207 in the camera 100. Alternatively, the refocus process may be performed by transmitting data of the LF image stored at the storage medium 206 to an external apparatus, such as a personal computer, to cause the refocus process to proceed thereat.

Note that the LF image may be subjected to one or more various image generation processes other than the refocus process. For example, the LF image may be subjected to a process in which data of a light beam that has passed through a region located at a predetermined distance or further from the optical axis of the imaging lens 201 is excluded from the calculation based upon the incident direction of light described above for the image process to enable an image at any desired aperture value to be generated.

Construction of Image-capturing Unit

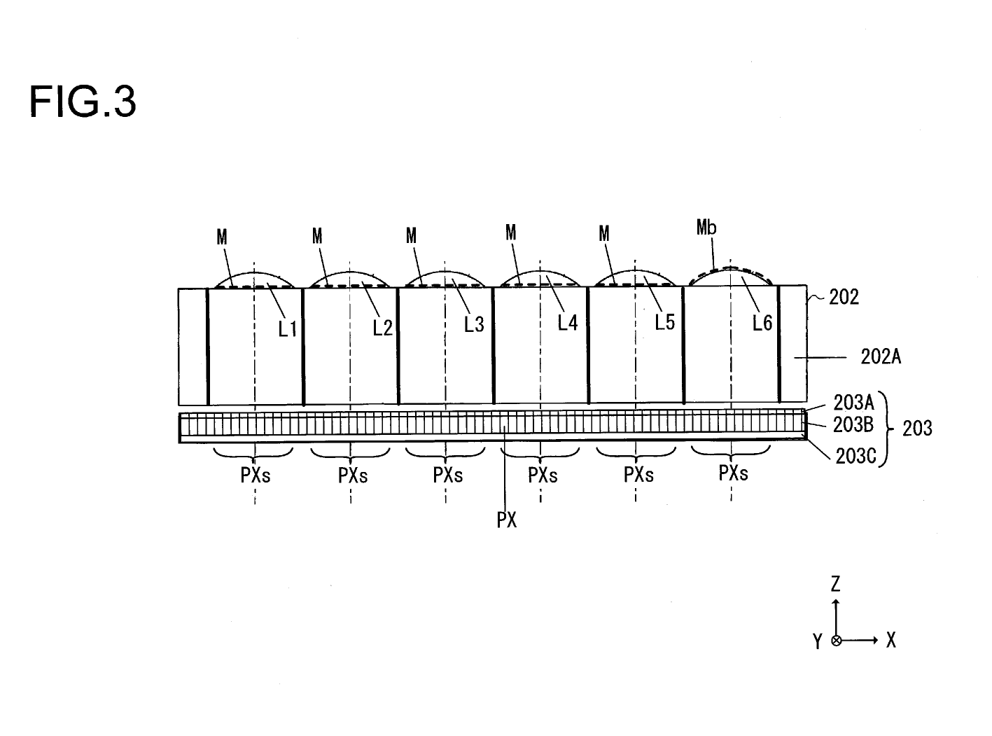

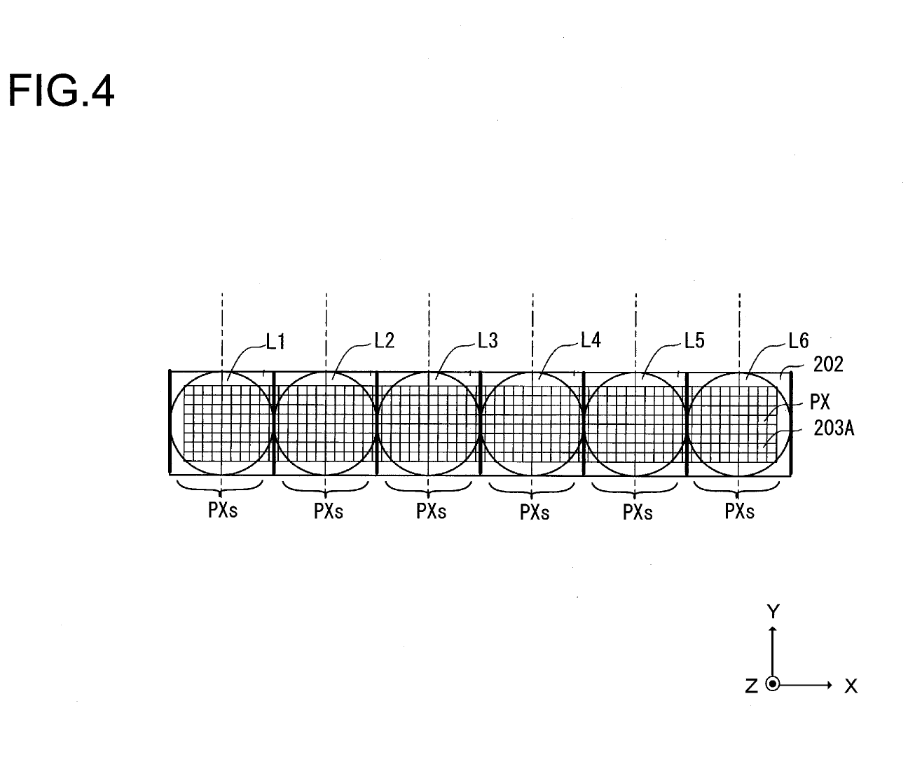

Now, concrete constitution examples of the image-capturing unit of the camera 100 are explained hereinbelow. FIG. 3 is a cross-sectional view illustrating the microlens array 202 and the image sensor 203, showing a cross-section parallel to the X-Z plane. FIG. 4 is a front view of the image sensor shown in FIG. 3 as seen from the +Z axis direction. In FIGS. 3 and 4, the image sensor 203 is provided behind the microlens array 202 (in the −Z axis direction).

Microlens Array

The microlens array 202 includes, for example, microlenses L1 to L6 and an optically transparent substrate 202A integrally formed therewith. The transparent substrates 202A that can be used include a glass substrate, a plastic substrate or a silica substrate. The microlens array 202 may be formed by injection molding, compression molding, or the like.

Note that the microlenses L1 to L6 may be formed separately from the transparent substrate 202A.

Image Sensor

The image sensors 203 shown in FIG. 3 may be, for example, a CCD image sensor or a CMOS image sensor. The image sensor 203 has, for example, a silicon substrate 203C, a photodetector array 203B formed on the silicon substrate 203C, and a color filter array 203A formed on the silicon substrate 203C in order from the −Z axis direction.

In FIG. 4, the color filter array 203A of the image sensor 203 is located behind the microlenses L1 to L6 of the microlens array 202 (in the −Z axis direction). The color filter array 203A includes a plurality of filters that selectively transmit lights, for example, having wavelength regions of RGB (red, green, and blue), respectively, corresponding to the pixels PX of the photodetector array 203B, arranged in the form of a two-dimensional array. A pixel group PXs constituted by a predetermined number of pixels PX is allotted to each of the microlenses L1 to L6.

Note that in case no color information is needed, it is possible to omit the color filter array 203A.

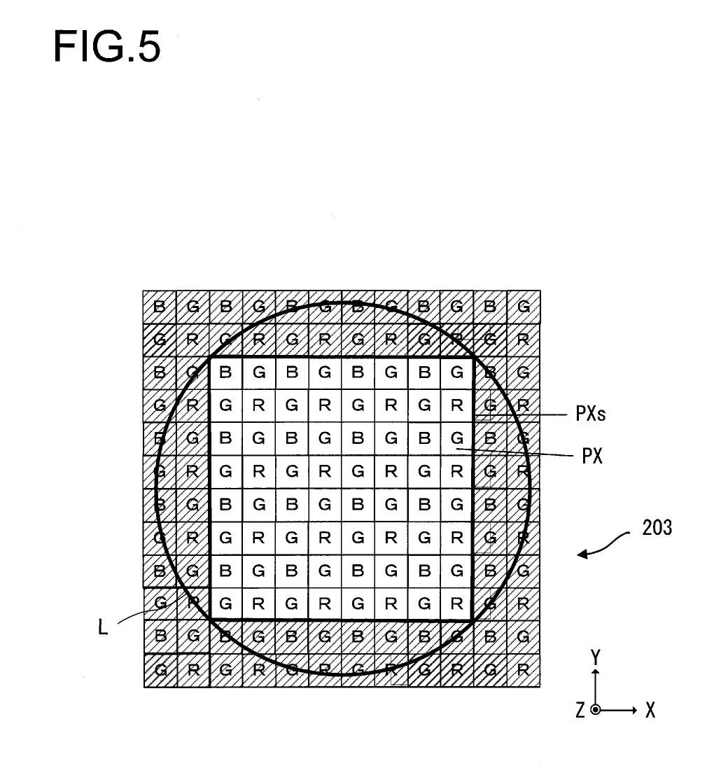

FIG. 5 is an enlarged diagram illustrating only one of the microlenses shown in FIG. 4. In FIG. 5, R (red), G (green), and B (blue) indicate wavelength regions of lights that are photoelectrically converted at the pixels PX of the photodetector array 203B. The color filter array 203A transmits light having any one of wavelength regions R, and B to the pixels PX of the photodetector array 203B. For example, filters that transmit B and G lights, respectively, are alternately arranged at respective pixel positions in odd number rows and filters that transmit G and R lights, respectively, are arranged at the respective pixel positions in even number rows.

Note that in FIG. 5, those pixels that constitute the pixel group PXs among the plurality of pixels PX are indicated with white background and pixels other than those that constitute the pixel group PXs are indicated with oblique lines.

A photodetector such as a photodiode is arranged at each pixel PX of the photodetector array 203B. The photodetector array 203B includes a plurality of pixels PX installed in a two-dimensional array as shown in FIGS. 4 and 5. Each pixel PX receives any one of B, G and R lights that enter it through the color filter array 203A. Each pixel PX produces electric charge that corresponds to the quantity of light that enters the photodiode. The electric charge stored at each pixel PX is transferred by an unshown transfer transistor to a charge transfer electrode, from which it is read out.

Here, the image sensor 203 has a structure of the backside illumination type in which the photodiode of the pixel PX is provided at the backside of the charge transfer electrode (in the +Z axis side). Generally, the image sensor of the backside illumination type can be configured to have a width greater than that of the image sensor of the front side illumination type. This prevents a decrease in the quantity of light that is photoelectrically converted at the image sensor 203. As a result, lights having sufficient intensities are enabled to enter the pixels PX without providing a condenser lens for each pixel PX. Therefore, a configuration may be adopted in which no other lens is provided between the microlens array 202 and the image sensor 203.

Note that the image sensor 203 may have a structure of the front side illumination type instead of the structure of the backside illumination type.

Although FIGS. 4 and 5 show an example of the image sensor in which a pixel group PXs constituted by 8×8 pixels is allotted to each of the microlenses L1 to L6. However, the number of the pixels PX is not particularly limited to the number of the pixels in the illustrated example. Also the number of the microlenses L1 to L6 shown in FIG. 4 is not limited to the number of microlenses in the illustrated example. Furthermore, the pixels PX in the photodetector array 203B may be arranged so that the pixel groups PXs are arranged isolated in correspondence to each microlens L as shown in FIG. 2 or a plurality of pixels PX may be arranged in a two-dimensional array without being isolated into the pixel groups PXs as shown in FIGS. 4 and 5.

Mask

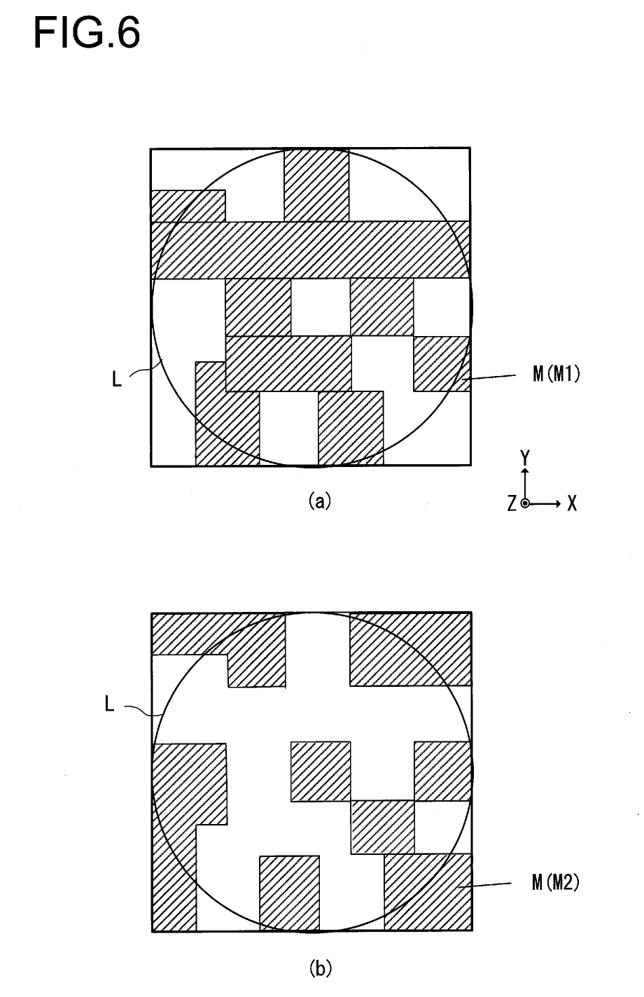

Masks M, each of which is formed of a coded opening (or coded aperture), are added to the corresponding microlenses L of the microlens array 202. FIGS. 6(a) and 6(b) illustrate opening patterns of the masks M, respectively. The coded opening formed at the mask M is a pattern having a random shape that allows transmission of light therethrough. Addition of a mask M to a microlens L enables a portion of light ray information (light incident from a predetermined direction) that is obtained by the pixel group PXs arranged behind that microlens L to be limited. The mask M is provided in order to obtain the effect of correction of image blurring achieved by the VR calculation.

The mask M is added between the microlens Land the transparent substrate 202A as is the case of the masks added to the microlenses L1 to L5 shown in FIG. 3. That is, the mask M is formed on the light emission surface side of the microlenses L. Note that the mask may be added on the surface of a microlens as is the case of a mask Mb, which is added to the microlens L6. That is, the mask Mb may be formed on the incident surface of the microlens L6.

FIG. 3 illustrates the example in which the masks M provided between the Microlens L and the transparent substrate 202A and the mask Mb provided on the surface of the microlens L6 are mixed. However, the masks may be added to the microlens uniformly either according to the manner of addition of the masks M or according to the manner of addition of the mask Mb.

In FIGS. 6(a) and 6(b), the portions with oblique lines of the mask M indicate areas having light transmittance that is reduced to a predetermined value (for example, 5%) or lower. The white background portions of the mask M indicate areas through which light is transmitted. The portions with oblique lines of the mask M shown in FIG. 6(a) has a shape obtained by randomly forming a plurality of rectangles or squares each having a sides greater than the pitch of the pixels PX of the photodetector array 203B and by randomly arranging such rectangles. The minimum widths of the rectangle in the X axis direction and in the Y axis direction are set greater than the pitch of the pixels PX of the photodetector array 203B. In other words, the rectangles which constitute the areas with oblique lines have each a size in the direction of the X axis greater than the width of the pixel PX in the direction of the X axis and also have each a size in the direction of the Y axis greater than the width of the pixel PX in the direction of the Y axis. This configuration is adopted to enable the state of limitation of light ray information of incident light to be detected for each of the pixels PX arranged behind the microlens L to which the mask M is added.

In this embodiment, all the microlenses L that constitute the microlens array 202 are each provided with a mask M. As for the opening patterns of the masks M, coded openings having mutually different patterns may be formed at all the microlenses L or coded openings having one and the same opening pattern may be formed at all the microlenses L.

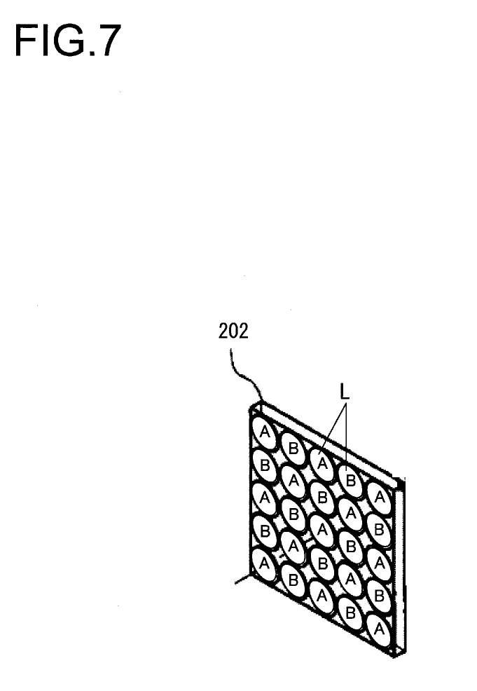

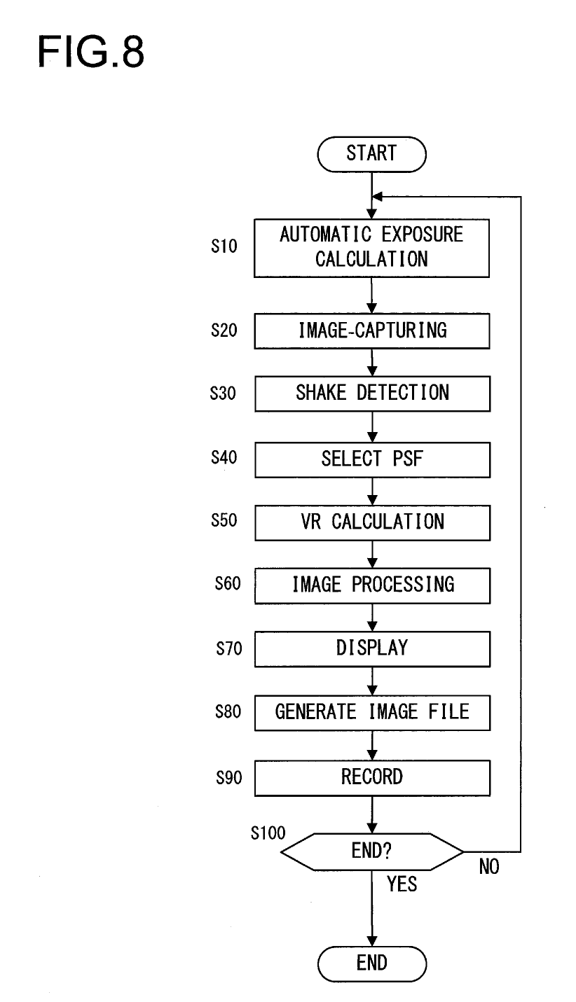

In this embodiment, all the microlenses L that constitute the microlens array 202 are divided into two groups and two types of opening patterns of the masks M are adopted. That is, masks M with two types of opening patterns, i.e., masks M1 and M2 are provided. The masks M1 and M2 are used at the two groups of the microlenses, respectively. For example, as illustrated in FIG. 7, all the microlenses L which constitute the microlens array 202 are divided into two groups A and B, arranged so as to form a checkerboard pattern.

According to the opening patterns of the masks M, the mask M having an opening pattern as shown in FIG. 6(a) is named M1 and the mask M having the portions with oblique lines and the white backgrounds in a pattern reversed with respect to the mask M1 as shown in FIG. 6(b) is named M2. Here, the masks M1 and M2 are each adjusted to have an opening ratio such that the quantity of light incident to the image sensor 203 (photodetector array 203B) is, for example, about half the quantity of light incident to the microlens to which no mask M is added. This is because use of the masks M having lower opening ratios produces darker images at the image sensor 203 and use of the masks M having higher opening ratios makes the effect of correction of image blurring performed by the VR calculation lower.

Note that in case priority is put on the effect of correction of image blur, the masks M may be adjusted so as to have opening ratios of lower than 50%. On the other hand, in case priority is put on the brightness of the images to be obtained, the masks M may be adjusted to have opening ratios of higher than 50%.

The masks M1 are added to the microlenses L of the group A in FIG. 7 and the masks M2 are added to the microlenses L of the group B in FIG. 7. Providing a plurality of adjacent microlenses L with masks having the same opening pattern (for example masks M1) causes all those microlenses to receive limited incident light from the same direction. On the other hand, as in this embodiment, providing a plurality of adjacent microlenses L with masks M1 and M2 having different opening patterns causes light incident from a predetermined direction to be limited with the masks M1 while this causes the light incident from the same direction as the predetermined direction not to be limited with the masks M2. That is, the limited light ray information for the pixel group PXs arranged behind the microlens L, to which is added, for example, masks M1, is obtained with some limitation while similar light ray information for the pixel group PXs behind the microlens L, to which masks M2 are added, can be obtained without limitations. The configuration of this embodiment enables not all lights that are incident from a specified direction to be limited at each of the plurality of adjacent microlenses L. That is, at least one of the adjacent pixel groups PXs enables light information about the light incident from the specified direction to be obtained.

The method in which all the microlenses L that constitute the microlens array 202 are divided into two groups, i.e., group A and group B is not limited to the division into two in a checkerboard pattern. Division of the microlenses L into two groups may be achieved by selecting microlenses in every other line of the microlens array 202 or by selecting microlenses L in every other row of the microlens array 202.

As a variation of this embodiment, instead of adding masks M to all the microlenses L that constitute the microlens array 202, a configuration may be adopted in which a portion of the microlenses L that constitute the microlens array 202 is provided with masks M and other microlenses L are provided with no masks M. In this case, too, the opening pattern of the mask M may be mutually different among the plurality of microlenses to which masks M are added or may be the same among the plurality of the microlenses L to which the masks M are added.

In case masks M are added to a portion of the microlenses L, the light ray information similar to the limited light ray information for the pixel group PXs arranged behind the microlens L to which the masks M are added can be obtained without limitation for the microlens L arranged behind the microlens L to which no masks M are added.

VR Calculation

A blurred image caused by vibration of a subject image with respect to the image sensor 203 is expressed by convolution of an original image that has no blur with a Point Spread Function (hereafter, referred to as “PSF”) as expressed by a formula (1) below.

y=fd*x (1)

where y represents a blurred image, fd represents PSF, * represents convolution integration, and x represents an original image of an original.

The formula (1) above is subjected to Fourier transformation to express it in terms of spatial frequency. Then, the convolution integration is expressed as a product as shown in a formula (2) below.

F(y)=F(fd)·F(x) (2)

where F(y) represents Fourier transformation of a blurred image y. F(fd) represents Fourier transformation of PSF and F(x) represents Fourier transformation of the original image x.

Reverse operation of the formula (2) above enables estimation of the original image x. That is, by dividing the blurred image by PSF in the frequency space according to the formula (2) above, the frequency characteristics of the original image x can be obtained. Furthermore, inverse Fourier transformation of the frequency characteristics enables a formula (3) to be derived.

x′=F⁻¹(F(y)/F(fd)) (3)

where x′ represents estimated (reproduced) original image and F⁻¹ (g) represent inverse Fourier transformation of the function g. According to the formula (3) above, a blurred image can be restored to original image x′ if PSF is known.

Accordingly, a plurality of PSFs is recorded in advance at the memory 205a in the control unit 205. For example, various PSFs that correspond to acceleration information are recoded in the memory 205a in the form of an LUT (Look UP Table) in which acceleration information is taken as argument. Note that PSF of the blur may be obtained from the PSF of the microlens L and the acceleration information by calculation. The control unit 205 defines an image based on the pixel signal read out from the image sensor 203 as a blurred image y and reads out PSF corresponding to the acceleration information obtained by the shake detector 204 from the memory 205a. And the control unit 205 performs calculation of the formula (3) as the VR calculation. In other words, the control unit 205 corrects image blurring by using the information (PSF which differs according to the value of acceleration information) stored at the memory 205a being a storage unit. This enables an image free of image blurring, i.e., original image x′, to be obtained by calculation.

As described above, the control unit 205 functions a correction unit that corrects the image blurring of the blurred image y obtained at the pixel group PXs through microlens L for which incident light is limited based on the acceleration information detected by the shake detector 204.

The image processing unit 207 performs the above-mentioned refocus process to the original image x′, thereby synthesizing an image on any image plane. That is, the image processing unit 207 functions as an image synthesis unit that synthesizes the image at any image plane based on the original image x′ that is corrected by the control unit 205.

Explanation of Flowchart

FIG. 3. is a flowchart illustrating the process flow of camera processing performed by the control unit 205. The control unit 205 starts the program for performing the process shown in FIG. 8 when an ON operation of the main switch is performed or when a recovery operation from a sleep state is performed. In a step S10 of FIG. 8, the control unit 205 starts automatic exposure calculation when, for example, releasing operation is performed and then the control proceeds to a step S20. The control unit 205 obtains the brightness of a subject based on a photometric value measured by an unshown photometric sensor and performs exposure control at the time of image-capturing according to the obtained brightness.

In the step S20, the control unit 205 drives the image sensor 203 to start image-capturing action and then the control proceeds to a step S30. In the step S30, the control unit 205 performs shake detection of the camera 100 at the time of image-capturing. Specifically, a detection signal from the shake detection unit 204 is inputted to the control unit 205 and then the control proceeds to a step S40.

In the step S40, the control unit 205 selects PSF that corresponds to the acceleration information indicated by the detection signal from the shake detector 204. In this embodiment, PSF that corresponds to the acceleration information out of the PSFs recorded at the memory 205a is read out and then the control proceeds to a step S50.

In the step S50, the control unit 205 performs VR calculation. The control unit 205 performs calculation according to the formula (3) described above to an LF image of group A based on the pixel signal read out from the pixel group PXs arranged behind the microlens L of the group A in FIG. 7 (in the −Z axis direction) to calculate original image of the group A. The original image of the group A calculated here is an image from which the portions corresponding to the group B are deleted. Also, the control unit 205 performs calculation according to the formula (3) described above to an LF image of group B based on the pixel signal read out from the pixel group PXs arranged behind the microlens L of the group B in FIG. 7 (in the −Z axis direction) to calculate original image of the group B. The original image of the group B calculated here is an image from which the portions corresponding to the group A are deleted. By superposing the original image of the group A and the original image of the group B one on another to supply a shortage in one original image from another original image, an original image can be obtained. This original image is an LF image, which is free of image blurring.

In the step S60, the control unit 205 sends an instruction to the image processing unit 207 to cause predetermined image processing to be performed to the LF image, which is free of image blurring, and then the control proceeds to a step S70. The image processing is, for example, the refocus process for generating an image at any focus position or viewpoint. Note that the image processing may include, for example, contour emphasis processing, color interpolation processing, and white balance processing.

Note that the order of the step S50 (VR calculation) and the step S60 (image processing) may be reversed. That is, calculation of an original image free of image blurring (LF image) may be performed by first combining the LF image of the group A with the LF image of the group B and subsequently performing VR calculation according to the formula (3) above to the resulting one LF image after the combination. In other words, the control unit 205 may function as a correction unit that corrects image blurring of the image synthesized by the image processing unit 207.

The automatic exposure calculation in the step S10 is not always necessary and image-capturing may be performed under predetermined exposure conditions, for example, under manually set exposure conditions. The step S20 and the step S30 may be performed in a reversed order or may be performed simultaneously.

In the step S70, the control unit 205 causes the image after image processing to be reproduced and displayed by the display unit 208 and then the control proceeds to a step S80.

The control unit 205 causes the image processing unit 207 to perform a second refocus process based on, for example, an operation from the user and to reproduce and display the refocused image generated by the second refocus process at the display unit 208. For example, in case a portion of the refocused image displayed at the display unit 203 is subjected to a tap operation by the user, the control unit 205 causes a refocused image which is focused on the subject displayed at the tap position to be displayed at the display unit 208.

In the step S80, the control unit 205 generates an image file and then the control proceeds to a step S90. The control unit 205 generates an image file that contains, for example, data of an LF image (LF image from which image blurring is removed) and data of a refocused image.

The control unit 205 may also generate an image file that contains only the data of the LF image (LF image from which image blur is removed) or an image file that contains only the data of the refocused image.

Furthermore, the control unit 205 may generate an image file that contains data of an LF image of the group A from which no image blurring is removed and data of an LF image of the B group from which no image blurring is removed. In case the image file contains data of the LF image from which no image blurring is removed, acceleration information that is needed in VR calculation to be performed later, that is, acceleration information detected by the shake detector 204 at the time of image-capturing is also correlated to the data of the LF image in advance.

In the step S90, the control unit 205 records the image file at the recording medium 206 and then the control proceeds to a step S100. In the step S100, the control unit 205 makes a determination as to whether to terminate the process. For example, when an OFF operation is done onto the main switch or when a predetermined time has elapsed in the absence of operations, the control unit 205 makes an affirmative determination at the step S100 and terminates the process illustrated in FIG. 8. On the other hand, the control unit 205 makes a negative determination at the step S100, for example, when an operation is done to the camera 100 and then the control returns to the step S10. The control unit 205, which has returned to the step S10, repeats the above-mentioned processes.

According to the first embodiment, the following operations and effects are obtained.

(1) The camera 100, which is an example of an optical device, includes the image sensor 203 and a plurality of microlenses L arranged two-dimensionally such that light that has passed one microlens L enters a plurality of pixel groups PXs that the image sensor 203 has, i.e., the microlens array 202. To a plurality of microlenses L of the microlens array 202 are added masks M that have coded openings with random shapes limiting a portion of incident light. This configuration enables the camera to have a reduced size as compared with the case where it includes the imaging lens 201 that is provided with a coded opening having a random shape.

(2) The masks M, which are added to the microlenses L, include masks having two types of opening patterns, i.e., the masks M1 and M2. As a result, light, which is similar to the light that is limited for the pixel groups PXs arranged behind the microlens L to which the mask M1 is added, enters the pixel groups PXs arranged behind the microlens L to which the mask M2 is added without limitation. Consequently, it will not happen that at each of a plurality of adjacent microlenses L, light incident from a specified direction is entirely limited. That is, at least one of a plurality of adjacent pixel groups PXs enables light ray information about light incident from the specified direction to be obtained.

(3) Like the mask Mb shown in FIG. 3, the opening pattern of the mask Mb to be added to the microlens L6 is formed on the incident surface side of the microlens L6. In so doing, the opening pattern can be formed by, for example, printing it on the surface of the microlens L6.

(4) Like the mask M in FIG. 3, the opening pattern of the mask M to be added to the microlens L5 is formed on the light emission surface side of the microlens L5. In so doing, the opening pattern can be formed by transferring it on the upper surface (on the +Z axis side surface) of the transparent substrate 202A, for example, before integrating the microlens L5 with the transparent substrate 202A.

(5) The camera 100 includes the control unit 205 that corrects image blurring of the LF image obtained at the pixel group PXs through the microlens L based on the acceleration information detected by the shake detector 204. This configuration enables the image blurring of the LF image caused by the swinging or shaking of the camera 100 to be removed by correction processing, for example, VR calculation.

(6) The camera 100 includes the image processing unit 207 that synthesize an image at any image plane by, for example, a refocus process based on the LF image from which the image blurring has been removed by the VR calculation performed by the control unit 205 as described in (5) above. This configuration enables refocus process to be performed based on the LF image after image blurring is removed.

(7) The image processing unit 207 of the camera 100 synthesizes an image at any image plane by, for example, a refocus process based on the LF image obtained at the pixel group PXs through the microlens L. The control unit 205 corrects the image blurring of the refocused image synthesized by the image processing unit 207. With this configuration, the correction of the image blurring, for example, VR calculation can be performed to the image at any image plane after the refocus process.

(8) The camera 100 includes the memory 205a that stores PSF to be used by the control unit 205 in the correction of image blurring, for example, VR calculation. Since the control unit 205 corrects image blurring by using the PSF stored at the memory 205a, necessary PSF is read out from the memory 205a as appropriate and used in the VR calculation. This enables the image blurring to be removed properly.

(9) The memory 205a of the camera 100 stores point spread functions, which differ depending on the acceleration information, as information to be used in correction of image blur, for example, VR calculation. This enables use of suitable PSF corresponding to the shake of the camera 100 to remove the image blurring properly.

The following variations are also within the scope of the present invention and one or more variations may be combined with the above-mentioned embodiment.

### Variation 1

In the above-mentioned embodiment, an example has been explained in which all the microlenses L that constitute the microlens array 202 are divided into two groups and two types of opening patterns for mask M are used properly. However, three or more types of opening patterns for masks may be provided. In case three or more types of opening patterns are provided, all the microlenses L that constitute the microlens array 202 are divided into three or more groups accordingly and then the three types or more of opening patterns are used for the groups, respectively. In case all the microlenses L of the microlens array 202 is divided into three or more groups, it is desirable to avoid uneven distribution of the microlenses L to which masks M with the same type of opening patterns are added and dot them evenly in the microlens array 202. Increasing the number of types of the opening patterns lessens generation of moire in images.

### Variation 2

The opening pattern of the mask M is not limited to the shape obtained by combining a plurality of rectangles as mentioned above and may have a shape that is obtained by combining polygonal openings such as triangular openings or hexagonal openings. Also, it may have a shape that is obtained by combining circular openings or elliptical openings.

Furthermore, it may be formed by arranging the openings in a spiral form.

### Variation 3

In the above-mentioned embodiment, an example has been explained in which the portions with oblique lines of the mask M have a reduced light transmittance of a predetermined value (for example, 5%) or less. However, the portions with oblique lines of the mask M may have an increased light transmittance, for example, up to 30% or 50%. The reason is that in case the need for correction of image blurring is low, that is, in case the acceleration information detected at the shake detector 204 at the time of image-capturing is a predetermined value or less, the pixel signals from the pixels PX corresponding to the portions with oblique lines at the mask M are used as data of the LF image.

Specifically, the pixel signals from the pixels PX corresponding to the portions with oblique lines at the mask M are multiplied by a gain that corresponds to the light transmittance and the products are used as data of the LF image. For example, in case the light transmittance of the portions with oblique lines at the mask M is 30%, the pixel signals are multiplied by a gain of about 3 times compared with the pixel signals from the pixels PX corresponding to the white background at the mask M, thereby enabling the pixel signals from the pixels PX corresponding to the portions with oblique lines at the mask M to be treated as data having the same signal level as that of the pixel signal from the pixels PX corresponding to the white background at the mask M. As a result the light information that is limited for the pixel groups PXs arranged behind the microlens L to which the mask M is added can be utilized.

### Second Embodiment

In the second embodiment, a configuration is adopted in which no mask M is added to some of the microlenses L that constitute the microlens array 202. Furthermore, focus detection processing is performed by using pixel signals read out from the pixel groups PXs arranged behind the microlens L to which no mask M is added.

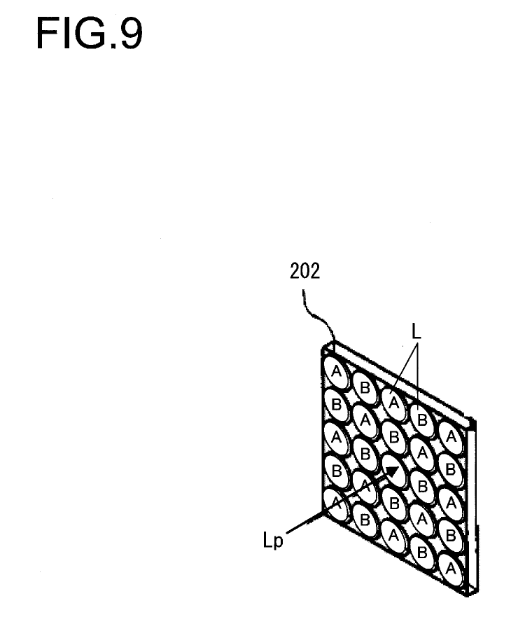

FIG. 9 is a diagram illustrating the microlens array 202 in the second embodiment. The microlens array 202 in the second embodiment differs from the one shown in FIG. 7 explained in the first embodiment in that no mask M is added to a central microlens Lp according to the second embodiment.

Note that the position of the microlens Lp to which no mask M is added is not always the center of the microlens array. There may be one or more microlenses Lp to which no mask M is added.

The control unit 205 detects an amount of image blurring (phase difference) between a pair of images formed by a pair of beams of light based on pixel signals read out from those pixels PX corresponding to the pair of beams of light that pass through different areas of the imaging lens 201 out of the pixel group PXs arranged behind the microlens Lp, thereby calculating the focus adjustment state (defocus amount) of the imaging lens 201. In other words, the control unit 205 functions as a focus detection calculation unit that performs focus detection calculation based on the images obtained at the pixel group PXs through a microlens Lp for which incident light is not limited. The above-mentioned pair of images comes closer to each other in a so-called front focus state, in which the imaging lens 201 forms a sharp image of a subject in front of the predetermined focal plane. On the contrary the pair of images move further from each other in a so-called rear focus state, in which the imaging lens 201 forms a sharp image of the subject behind the predetermined focal plane. That is, the amount of relative position displacement of a pair of images corresponds to the distance from the camera 100 to the subject.

Calculation of such a defocus amount is publicly known in the art of camera and detailed explanation thereof is omitted.

The control unit 205 of the camera 100 performs automatic focus adjustment action so that the microlens array 202 is located at the predetermined focal plane of the imaging lens 201. The reason for this is that for example, if the photodetector array 203B is located at the focal surface of the imaging lens 201, lights that have passed through different areas of the imaging lens 201 gather at some pixels PX, thereby making it difficult to obtain Lf images having proper light ray information.

The control unit 205, at a predetermined position of the imaging plane (which is referred to as “focus detection position”), controls automatic focus adjustment (autofocus: AF) action, which adjusts focus for the corresponding subject (object). The control unit 205 outputs a drive signal for moving a focus lens that constitutes the imaging lens 201 to a focusing position. Based on this drive signal, a focus adjustment unit (not shown) moves the focus lens to the focusing position. The process that the control unit 205 performs for automatic focus adjustment is also called a focus detection process.

In the second embodiment, the automatic focus adjustment action performed by the control unit 205 is performed to move the focal position of the imaging lens 201 to become outside a range of 2 f, which is a sum of the distance f from the position of the photodetector array 203B in the +Z axis direction and the distance f from the position of the photodetector array 203B in the −Z axis direction, with the distance f corresponding to the focal distance of the microlens L that constitute the microlens array 202.

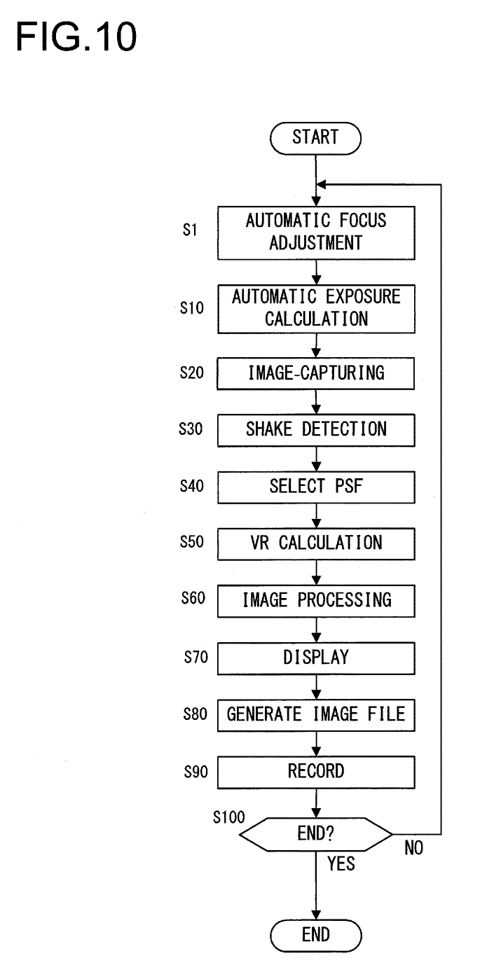

FIG. 10 is a flowchart illustrating process flow of the camera processing executed by the control unit 205. The second embodiment differs from the flowchart in FIG. 8 that has been explained in the first embodiment in that a step Si is provided upstream of the step S10 in the second embodiment.

In the step S1, the control unit 205 controls the automatic focus adjustment action and then the control proceeds to the step S10.

Note that the order of the step S1 (automatic focus adjustment) and the step S10 (automatic exposure calculation) may be reversed.

According to the second embodiment, use of the pixel signals read out from the pixel groups PXs arranged behind the microlens Lp to which no mask M is added enables focus detection process to be performed without providing any focus detection device.

Although various embodiments and variations have been explained above, the present invention is not limited to these. The embodiments and the variations may be combined in any combination as appropriate. Other aspects that are conceivable within the technical concept of the present invention are also encompassed within the present invention.

The disclosure of the following priority application is herein incorporated by reference:

Japanese Patent Application No. 2016-69738 filed Mar. 30, 2016

### Reference Signs List

100 . . . camera, 201 . . . imaging lens, 202 . . . microlens array, 203 . . . image sensor, 203B photodetector array, 204 . . . shake detector, 205 . . . control unit, 205a . . . memory, 206 . . . storage medium, 207 . . . image processing unit, L, Lp, L1 to L6 . . . microlenses, M, Ms . . . masks, PX . . . pixel, PXs . . . pixel group

1. An optical device, comprising:
a plurality of microlenses arranged in a two-dimensional shape; and
an image sensor having a plurality of pixel groups each containing a plurality of pixels, each of the plurality of pixel groups receiving light that has passed through each of the plurality of microlenses, wherein:
at least a part of the plurality of microlenses each limits a part of an incident light by an opening pattern formed at a microlense.

2. The optical device according to claim 1, wherein:
the plurality of microlenses include microlenses at which at least two types of opening patterns are formed.

3. The optical device according to claim 1, wherein:
the opening pattern is formed at an incident surface side of the microlens.

4. The optical device according to claim 1, wherein:
the opening pattern is formed at a light emission surface side of the microlens.

5. An optical device, comprising:
a plurality of microlenses arranged in a two-dimensional shape;
an image sensor having a plurality of pixel groups each containing a plurality of pixels, each of the pixel groups receiving light that has passed through each of the plurality of microlenses; and
a plurality of masks each having a predetermined opening pattern, wherein:
each of the plurality of masks limits light that is incident to each of at least a part of the plurality of microlenses.

6. The optical device according to claim 5, wherein:
the plurality of masks include masks that have at least two types of opening patterns.

7. The optical device according to claim 5, wherein:
the masks are arranged at an incident surface side of the microlenses.

8. The optical device according to claim 5, wherein:
the masks are arranged at a light emission side of the microlenses.

9. The optical device according to claim 1, further comprising:
a correction unit that corrects image blurring of an image obtained at the pixel groups through the microlenses by which incident light is limited, based on acceleration information detected by an acceleration detection sensor.

10. The optical device according to claim 9, further comprising:
an image synthesis unit that synthesizes an image at any image plane based on an image corrected by the correction unit.

11. The optical device according to claim 9, further comprising:
an image synthesis unit that synthesizes an image at any image plane based on images obtained at the pixel groups through the microlenses, wherein:
the correction unit corrects image blurring of the image synthesized by the image synthesis unit.

12. The optical device according to claim 9, further comprising:
a storage unit that stores information to be used in calculation of the correction by the correction unit, wherein:
the correction unit corrects the image blurring by using the information stored in the storage unit.

13. The optical device according to claim 12, wherein:
the storage unit stores a point spread function that differs depending on a value of the acceleration information as the information to be used in calculation of the correction.

14. The optical device according to claim 1, further comprising:
a focus detection calculation unit that performs focus detection calculation based on images obtained at the pixel groups through the microlenses by which incident light is not limited.
